(19) United States
(12) Patent Application Publication
(10) Pub. No.: US 2010/0083450 A1
(43) Pub. Date: Apr. 8, 2010

(54) APPARATUS FOR CLEANING MAGNETIC STRIPES

(76) Inventor: Arieh NAIDER, Beit Shemesh (IL)

Correspondence Address: DANIEL J SWIRSKY, 55 REUVEN ST., BEIT SHEMESH, 99544, IL

(21) Appl. No.: 12/247,030

(22) Filed: Oct. 7, 2008

(51) Int. Cl. B08B 7/00

(52) U.S. Cl. 15/97.1

(57) ABSTRACT

A magnetic stripe cleaning unit includes a base unit with a cleaning slot and a cleaning material positioned in the slot.

### FIELD OF THE INVENTION

The present invention relates to cards with magnetic stripes generally and to cleaning them in particular.

### BACKGROUND OF THE INVENTION

Magnetic stripe technology for storing information on plastic cards in known in the art. Such technology is typically used to produce a variety of personalized cards, including, for example, charge cards, bank cards, library cards, citizen ID cards, employee ID cards and driver's licenses. The information stored on the magnetic stripe of such cards identifies the user and/or his/her privileges vis-à-vis whoever issued the card.

The magnetic stripe on such cards is typically read by a magnetic stripe reader. For example, when a person uses a charge card to pay for a purchase at a store, the cashier passes or “swipes” the card through a magnetic stripe reader in order to read the information on the card and contact the issuer for payment authorization.

Magnetic stripe readers generally require close proximity with a magnetic stripe in order to read it. If the surface of the magnetic stripe isn't clean, the performance of a typical reader may be impacted and it may not be able to read the information on the magnetic stripe.

### SUMMARY OF THE PRESENT INVENTION

An object of the present invention is to improve upon the prior art.

There is therefore provided in accordance with a preferred embodiment of the present invention, a magnetic stripe cleaning unit including a base unit with a cleaning slot, and a cleaning material positioned in the slot.

Further, in accordance with a preferred embodiment of the present invention, the cleaning material is dry.

Still further, in accordance with a preferred embodiment of the present invention, the unit includes a housing to fix the cleaning material in position in the slot.

Moreover, in accordance with a preferred embodiment of the present invention, the unit also includes means to mount the cleaning unit in a static position.

Additionally, in accordance with a preferred embodiment of the present invention, the means include at least one of an adhesive and a screw assembly.

Further, in accordance with a preferred embodiment of the present invention, the cleaning material is felt.

Still further, in accordance with a preferred embodiment of the present invention, the cleaning material is non synthetic cotton cloth.

Additionally, in accordance with a preferred embodiment of the present invention, the cleaning material is replaceable.

Moreover, in accordance with a preferred embodiment of the present invention, the cleaning material is shaped to fit to contours of the base unit.

Further, in accordance with a preferred embodiment of the present invention, the cleaning material includes folds to provide support for positioning of the cleaning material according to the contours.

Still further, in accordance with a preferred embodiment of the present invention, the unit is implemented as part of an integrated cash register, where the unit is positioned in line with a built-in card reader.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a magnetic stripe cleaning unit designed and operative in accordance with a preferred embodiment of the present invention.

FIGS. 2A, 2B, 3 and 4 are schematic illustrations of components of the cleaning unit of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

During the course of every day usage, it is not uncommon that a magnetic stripe will accumulate dirt and other residue, rendering its associated card temporarily unusable until the magnetic stripe is cleaned. It will be appreciated that the user may not be aware of the situation until the next such time as it becomes necessary to use the card. This may cause inconvenience or even embarrassment for the user. For example, if the magnetic stripe is on a charge card, the user may have difficulty paying for a purchase at a store. This may inconvenience not only the user, but also anyone else waiting in the cashier's line at the store. Often times the cashier may improvise a “solution” to the problem by wiping the magnetic stripe clean on a piece of cloth or clothing. There are spray based chemical products that may be used to clean a magnetic stripe, but their use may be inconvenient and messy at a point of sale.

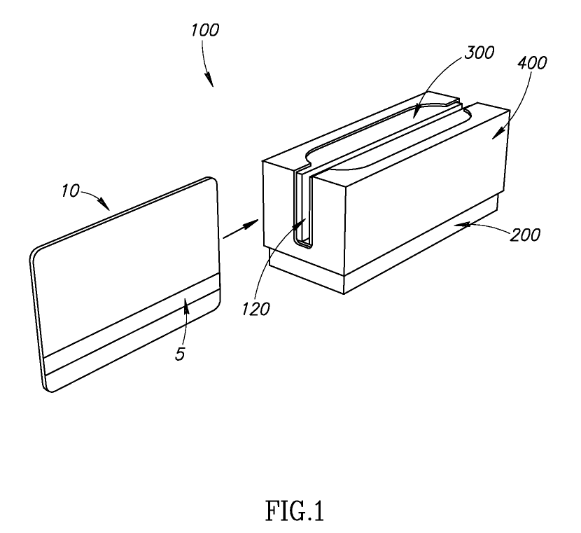

The present invention provides an easy to use solution to quickly and efficiently clean magnetic stripes as necessary. Reference is now made to FIG. 1 which illustrates a novel magnetic stripe cleaning unit 100 designed and operative in accordance with a preferred embodiment of the present invention.

Cleaning unit 100 may comprise a base unit 200, a cleaning material 300, and a housing 400. In accordance with a preferred embodiment of the present invention, cleaning material 300 may be made of non synthetic cotton based cloth. In accordance with another embodiment of the present invention, cleaning material 300 may be made of felt. It will be appreciated that the use of cotton cloth or felt may be exemplary; cleaning material may be made of any material suitable for wiping unwanted substances off of a magnetic stripe.

Cleaning unit 100 may also comprise a cleaning slot 120. Slot 120 may be slightly wider than the width of a typical card with a magnetic stripe. An exemplary width for cleaning slot 120 may be 2 millimeters. As will be described hereinbelow, cleaning material 300 may be fitted to generally adhere to the contours of cleaning slot 120, such that when a plastic card 10 with a magnetic stripe 5 may be passed or “swiped” along slot 120, cleaning material 300 may wipe off the surface of magnetic stripe 5.

In accordance with a preferred embodiment of the present invention, cleaning unit 100 may be fixed in place for convenient use. For example, an adhesive (not shown) may be applied to a side of unit 100 in order to mount it on the side of a cash register. When and if a register's magnetic stripe reader fails to read the information on magnetic stripe 5, the cashier may simply swipe card 10 through cleaning unit 100 in order to easily and efficiently clean magnetic stripe 5.

It will be appreciated that mounting unit 100 with an adhesive may be exemplary. The present invention may also include other apparatus for fixing unit 100 in place. For example, a screw assembly may also be used.

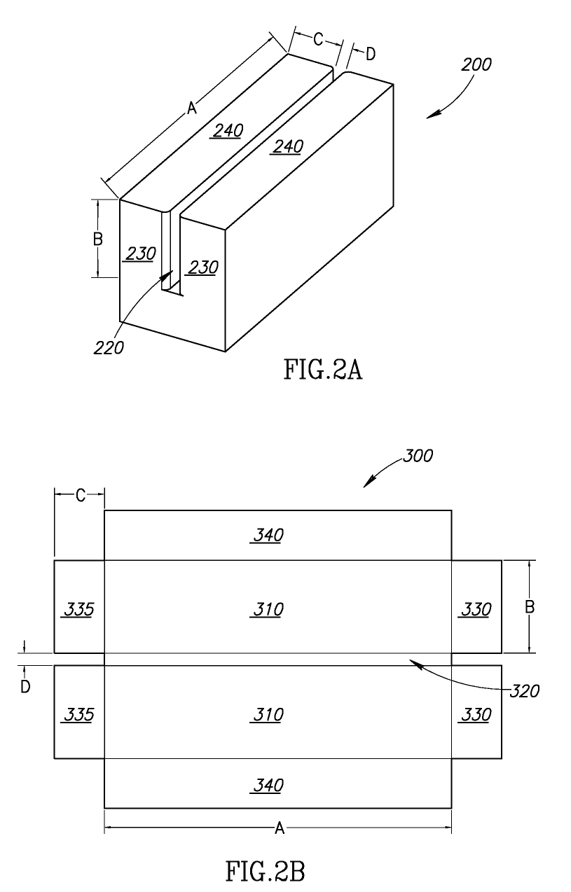

FIGS. 2A and 2B, to which reference is now made, together illustrate an exemplary base unit 200 and cleaning material 300 as disassembled from cleaning unit 100.

FIG. 2A shows a base unit 200, designed and operative in accordance with a preferred embodiment of the present invention. Base unit 200 may comprise frontal surfaces 230 and top surfaces 240. As shown in FIG. 2A, surfaces 230 and 240 may both have a width of “C”. Surface 240 may have a length of “A”; 230 may have length of “B”. Slot 220 may be a narrow opening between top surfaces 240 with a width of “D” and may extend to a depth roughly corresponding to “B”.

FIG. 2B shows an exemplary cleaning material 300, designed and operative in accordance with a preferred embodiment of the present invention. Cleaning material 300 may comprise a single piece of cleaning material, sectioned into cleaning surfaces 310, slot cover 320, frontal flaps 330, top flaps 340 and back flaps 335. It will be appreciated that cleaning material 300 may be dry; no liquids or chemical additives may be necessary to clean magnetic stripe 5. Accordingly the operation of unit 100 may have minimal impact on the environment in which it is used.

Cleaning surfaces 310 may be rectangular in shape and generally correspond to a length and width defined by “A” and “B” respectively. Slot cover 320 may be a narrow section of cleaning material 300 between surfaces 310 and generally correspond to a length and width defined by “A” and “D” respectively. Frontal and back flaps 330 and 335 extend from the front and back of cleaning surfaces 310 and may also be rectangular in shape. Each may have a length generally corresponding to “B” and a width generally corresponding to “C”. Top flaps 340 may extend from the sides of cleaning surfaces 310, and each may have a length generally corresponding to “A” and a width generally corresponding to “C”. The areas of surfaces 310 and flaps 330, 335 and 340 may be delineated by folds or creases in cleaning material 300.

It will be appreciated that cleaning surfaces 310 and slot cover 320 together may generally correspond in size and shape to the dimensions of the surfaces of slot 220. It will be similarly appreciated that front flaps 330 may generally correspond in size and shape to frontal surfaces 330, and side flap 340 may generally correspond in size and shape to top surfaces 340. Back flaps 335 may also generally correspond in size and shape to back surfaces of base unit 300 (not shown).

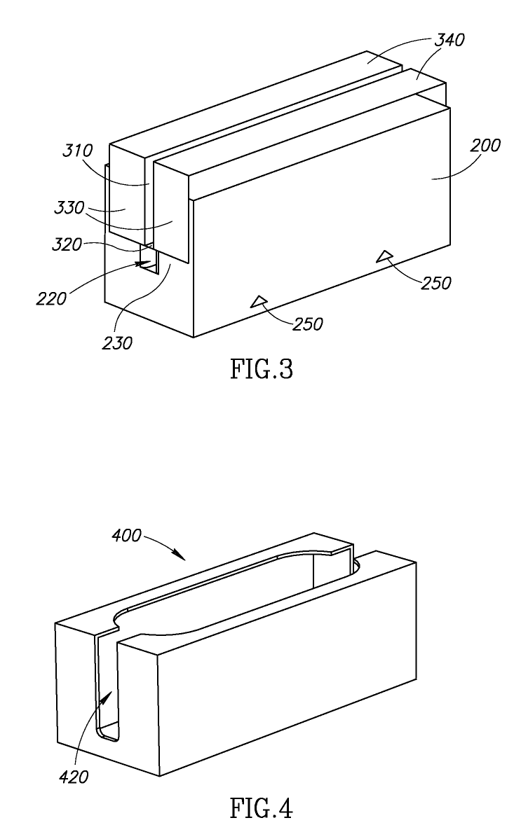

It will accordingly be appreciated that as shown in FIG. 3, to which reference is now made, cleaning material 300 may be placed on base unit 200 in such a manner as to cover the entire surface area of slot 220, while leaving an open area of close to “D” width in between opposing cleaning surfaces 310. Frontal and top surfaces 230 and 240 may also be covered by flaps 330 and 340. Back flaps 335 may similar cover back surfaces of unit 200 (not shown).

In accordance with a preferred embodiment of the present invention, base unit 200 may also comprise clasps 250 which may be positioned to catch and hold housing 400 when placed on top of unit 200.

Reference is now made to FIG. 4. FIG. 4 shows an exemplary housing 400 that may be fitted snugly over base unit 200 and cleaning material 300. Housing 400 may comprise a housing slot 420. Housing 400 may also comprise depressions on its interior sides that may be positioned opposite clasps 250 (FIG. 3) in a manner designed to fasten housing 400 to base unit 200. It will be appreciated that when housing 400 may be fitted to base unit 200, it may serve to hold cleaning material 300 in place, particularly cleaning surfaces 310. The location of housing slot 420 may generally correspond to that of slot 220, thus providing free passage for a card 10 to be swiped through cleaning slot 120 as shown in FIG. 1.

It will be further appreciated that when swiping card 10 through slot 120, cleaning surfaces 310 may come in contact with magnetic stripe 5 and they may thusly remove residues that may have accumulated on stripe 5.

In accordance with an exemplary embodiment of the present invention, the dimensions of cleaning unit 100 as defined to in FIGS. 2 may be as follows: “A” may be 60 millimeters; “B” may be 40 millimeters; “C” may be 12 millimeters; and “D” may be 2 millimeters. It will be appreciated that these may be exemplary dimensions. Other dimensions may be included in the present invention as well.

An exemplary thickness for cleaning material 300 may be 1 millimeter. It will be appreciated that the present invention may include other thicknesses for cleaning material 300. It will further be appreciated that the width of cleaning slot 120 may be a function of the thickness of cleaning material 300 as well and the thickness of whatever cards 10 may be targeted for cleaning by unit 100.

It will be appreciated that cleaning material 300 may be replaceable. Housing 400 may be removed in order to access and replace cleaning material 300.

In accordance with an alternative preferred embodiment of the present invention, cleaning unit 100 may be implemented as part of an integrated cash register. In such an implementation, a cleaning unit 100 may be placed in line with a cash register's built-in card reader, such that a card 10 may be swiped through both cleaning unit 100 and the card reader in a single movement.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A magnetic stripe cleaning unit comprising:
a base unit with a cleaning slot; and
a cleaning material positioned in said slot.

2. A unit according to claim 1 and wherein said cleaning material is dry.

3. The unit according to claim 1 and also comprising a housing to fix said cleaning material in position in said slot.

4. The unit according to claim 1 and also comprising means to mount said cleaning unit in a static position.

5. The unit according to claim 4 and wherein said means comprise at least one of an adhesive and a screw assembly.

6. The unit according to claim 1 and wherein said cleaning material is felt.

7. The unit according to claim 1 and wherein said cleaning material is non synthetic cotton cloth.

8. The unit according to claim 1 and wherein said cleaning material is replaceable.

9. The unit according to claim 1 and wherein said cleaning material is shaped to fit to contours of said base unit.

10. The unit according to claim 9 and wherein said cleaning material is folded to provide support for positioning of said cleaning material according to said contours.

11. The unit according to claim 1 and wherein said unit is implemented as an integrated cash register, wherein said unit is positioned in line with a built-in card reader.
